(19) United States
(12) Patent Application Publication
(10) Pub. No.: US 2020/0179735 A1
(43) Pub. Date: Jun. 11, 2020

(54) FLAME ARRESTER

(71) Applicant: R. Stahl Schaltgerate GmbH, Waldenburg (DE)

(72) Inventors: Thorsten Arnhold, Pfedelbach (DE); Clife Hermanowski, Seckach (DE)

(73) Assignee: R. Stahl Schaltgerate GmbH, Waldenburg (DE)

(21) Appl. No.: 16/617,682

(22) PCT Filed: May 24, 2018
(86) PCT No.: PCT/EP2018/063601

§ 371 Date: Nov. 27, 2019

(30) Foreign Application Priority Data
Jun. 1, 2017 (DE) 10 2017 112 162.5

(51) Int. Cl. A62C 4/00

(52) U.S. Cl. CPC A62C 4/00; B32B 5/12

(57) ABSTRACT

A flame arrester comprising two part-bodies, which consist of different wire fabric layers and are connected to one another by an intermediate layer of particularly coarse-meshed wire fabric. The coarse-meshed wire fabric preferably consists of a thick wire. Both the wire diameter and the mesh width of this intermediate layer are preferably much greater than the mesh widths and wire diameters of the wires used for the part-bodies. The pressure relief body combines a high degree of mechanical stability with a great flame arresting capability and at the same time very low flow resistance.

The invention relates to a flame arrester, in particular a flame arrester for use as a pressure relief body in explosion-proof housings consistent with protection class Ex-d.

Publication DE 10 2014 116 149 A1 discloses a flame arrester that comprises a larger number of wire fabric layers which display different mesh widths and wire thicknesses and preferably also different orientations. Due to the alternating mesh width and the angular offset of the individual layers relative to each other, labyrinth-like passages are formed, which, on the one hand, prevent a transmission of flame and, on the other hand, feature good gas permeability. The individual layers are connected to each other, for example by sintering. However, it has been found that such flame arresters, in the event of pulsed pressure loads as can occur in a housing due to explosions, are subject to a stronger flow in the center than in the peripheral zones.

It is the object of the invention to design a flame arrester having improved flow capability.

This object is achieved with the flame arrester according to claim 1:

The flame arrester according to the invention comprises a number of wire fabric layers having a mesh width which does not exceed a limit dₘₐₓ. In any event, the number of wire fabric layers is greater than two; preferably, there are five or more layers which define labyrinth-like pores. The flame arrester according to the invention comprises at least two such part-bodies formed by a number of wire fabric layers, between which an intermediate layer having a mesh width greater than the greatest mesh width within the defined mesh width range of the two part-bodies is arranged. The intermediate layer arranged between the two part-bodies forms a pressure distribution layer which allows a flow transverse with respect to the main flow direction, for example a radially oriented flow, and thus results in a pressure equalization within the intermediate layer. In particular, the pressure equalization can lead to an improved surface utilization of the pressure relief body when subjected to a pulsed pressure load and thus to a reduction of its flow resistance. Consequently, pressure peaks are reduced more effectively than before.

Due to the firm connection of the two part-bodies with the intermediate layer, there is additionally attained a particularly robust pressure relief body which may have a large surface.

The wire fabric layers preferably comprise wires having diameters within a specific wire diameter range D, whose upper limit dₘₐₓ is not exceeded by any of the wires of the wire fabric layers of the two part-bodies. The intermediate layer, however, preferably has wires having diameters d_{z}, which are greater than the greatest diameter dₘₐₓ within the wire diameter range D. Preferably, it applies—additionally or alternatively—that the mesh width m_{z} of the intermediate layer is at least 1.5 times greater than the greatest mesh width mₘₐₓ within the mesh width range M. Each of the two mentioned measures results in a lower resistance for transverse flows in the intermediate layer and thus in a good equalization of the pressure in the intermediate layer. Therefore, the flow resulting from the pressure wave is widened in the intermediate layer, so that the part-body downstream of the flow direction R is used over a larger surface than would be the case without intermediate layer.

The intermediate layer may be configured as a fabric, as well as a grid of intersecting wires and be formed by an equivalent structure. The possibility of the formation of transverse flows is essential.

Additional details of advantageous embodiments of the invention are the subject matter of dependent claims, the associate description, and the drawings. They show in

FIG. 1 a schematic cross-sectional display of the flame arrester according to the invention,

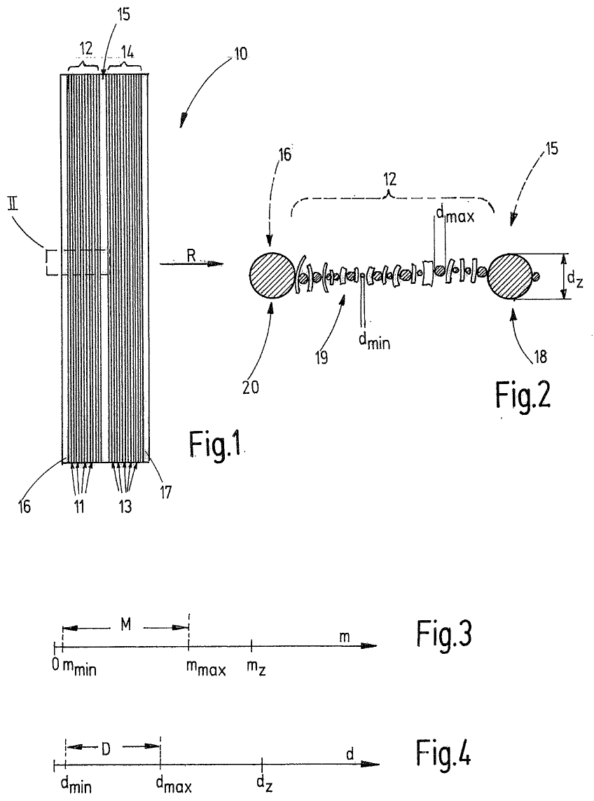

FIG. 2 a detail of the cross-section of the flame arrester according to FIG. 1,

FIGS. 3 and 4 diagrams illustrating the mesh widths and the wire diameters in the flame arresters according to FIGS. 1 and 2,

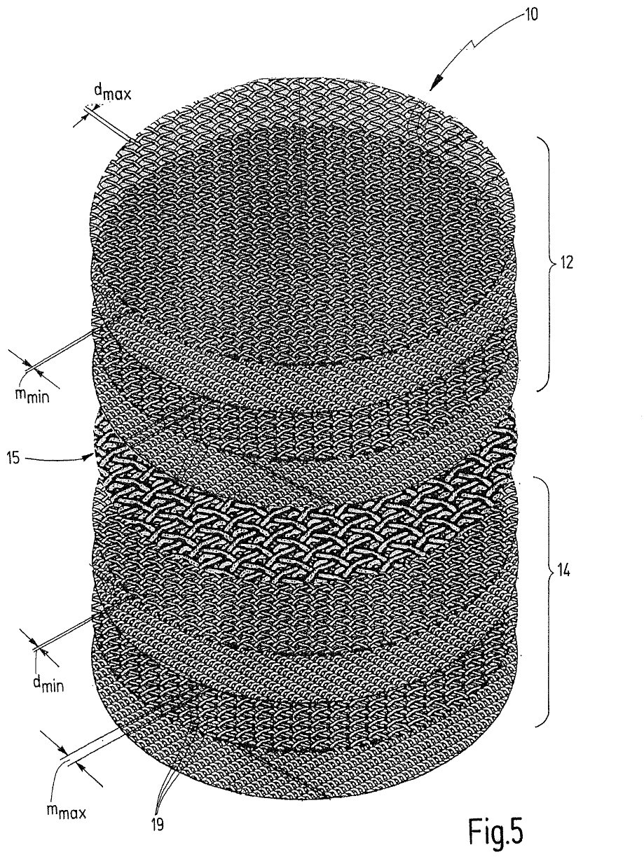

FIG. 5 a perspective exploded view of a detail of the flame arrester according to FIG. 1,

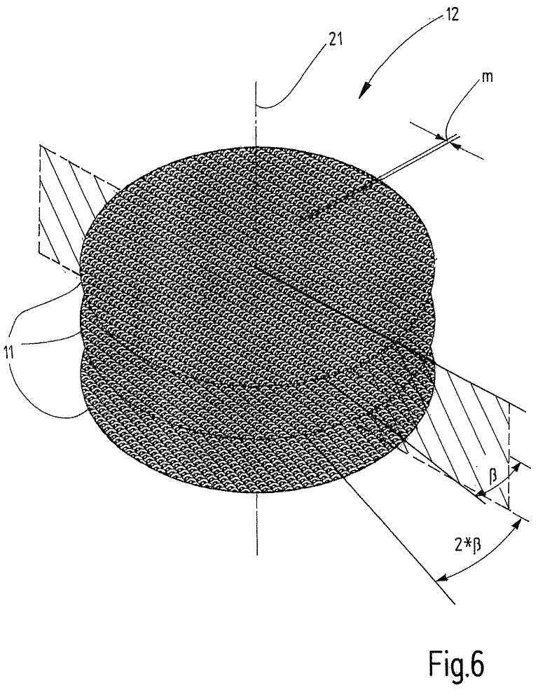

FIG. 6 a separate perspective exploded view of the wire fabric layers of the flame arrester according to FIGS. 1 to 5, and

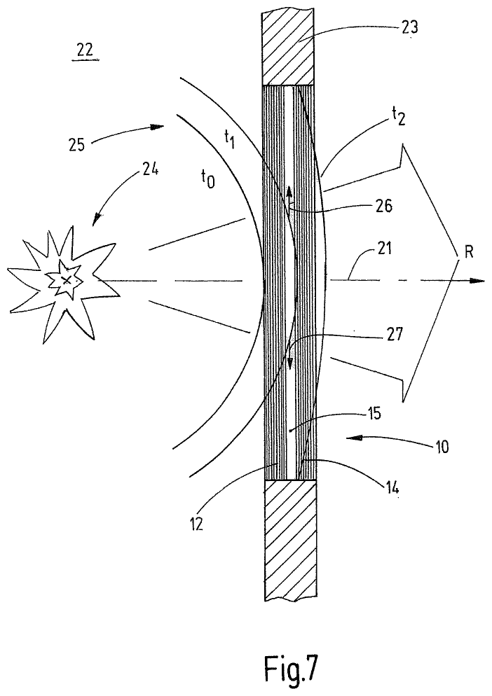

FIG. 7 a schematic cross-sectional display of the flame arrester according to FIG. 1 in a housing wall, while a pressure wave is impinging.

FIG. 1 shows a schematic diagram of a pressure relief body 10 which can be attached in or on a housing wall of an explosion-proof housing in order to allow a rapid pressure equalization between the interior space of the housing and the environment. The pressure relief body 10 comprises a first number of wire fabric layers 11 which form a first part-body 12. An additional number of wire fabric layers 13, which are connected to each other in a material-bonded manner and form a second part-body 14, is provided. The wire fabric layers connected to each other in the two part-bodies 12, 14, respectively, are preferably connected by being welded on their edges, in particular by sintering, so that a vast number of connecting points exist distributed over the surface of the wire fabric layers 11 and 13, respectively.

Between the two porous part-bodies 12, 14 there is arranged an intermediate layer 15 which preferably is configured as a wire fabric layer and which further preferably is connected to the two part-bodies 12, 14, preferably in a material bonded manner, for example by sintering. In this case, the part-bodies 12, 14 form a single sintered body with the intermediate layer 15. Furthermore, the pressure relief body 10 may be provided, on both its flat surfaces perpendicular to the flow direction R, with wire fabric layers 16, 17, which, for example consist of a wire fabric that matches the intermediate layer 15 or which has a mesh width and wire diameter subject to the same conditions as the intermediate layer 15.

FIG. 2 shows an enlarged detail II that comprises the intermediate layer 15, the part-body 12 and the cover layer 16. As is shown in a somewhat exaggerated way by FIG. 2, in doing so, the diameter d_{z} of the wire 18 of the intermediate layer 15 is clearly greater than any wire diameter in the part-body 12 (FIG. 4). In any event, the part-body 12 contains more than two, preferably a plurality of, wire fabric layers 11, which, preferably, take up the entire surface of the entire cross-section of the part-body 12. According to FIG. 4, the diameters d of the wires 19 present in the wire fabric layers 11 are within the wire diameter range D which ranges from a minimum diameter dₘᵢₙ to a maximum diameter dₘₐₓ. The lower wire diameter limit dₘᵢₙ is at approximately 0.1 mm, while the upper limit dₘₐₓ is preferably at most 1 mm. The wire diameter d_{z} of the wire 18 of the intermediate layer 15 is fixed outside this diameter range D. Preferably, the diameter d_{z} of the wire 18 of the intermediate layer 15 is at least 1.5 times greater than the greatest diameter dₘₐₓ of the diameter range D. This applies analogously to the wire 20 of the cover layer 16.

The wire diameters of the individual wires in the intermediate layer 15 may vary. However, it applies that at least the wires defining the distance between the two part-bodies 12, 14 such as, for example, the wire 18, have diameters d_{z} outside the diameter range D.

The conditions are similar regarding the mesh width m in the part-body 12 and in the intermediate layer 15. The mesh width m in the backing fabric layers 11—the part-body 12—is within the mesh width range M that ranges from a minimum mesh width mₘᵢₙ to a maximum mesh width mₘₐₓ. The minimum mesh width mₘᵢₙ is within the range of a tenth of a millimeter, while the maximum mesh width mₘₐₓ is within the range of one millimeter. The mesh width m_{z} of the intermediate layer is greater than the maximum mesh width mₘₐₓ occurring in the part-body 12, preferably at least 1.5 times greater.

Preferably, analogous conditions apply to the part-body 14. In doing so, however, the number of wire fabric layers 11 may differ from the number of wire fabric layers 13 in the part-bodies 12, 14.

FIG. 5 illustrates the structure of the pressure relief body 10 of a detail in an exploded view. As is obvious, both flat surfaces of the intermediate layer 15 are adjoined by the wire fabric layers 11 and 13 of the part-bodies 12 and 14. As is already obvious from FIG. 2, these may be made in different wire thicknesses and, in addition, may have different orientations. In addition to different wire thicknesses, each of the individual layers of the part-bodies 12 and 14, at least preferably, have different mesh widths m. Whereas the individual layers of the part-bodies 12, 14 have different mesh widths m within a mesh width range M, the mesh width m_{z} of the intermediate layer 15 is outside this mesh width range M.

FIG. 6 shows the preferably uneven angular orientation of three layers 11 of the part-body 12. In each layer, the wire fabric consists of warp wires, which are parallel to each other, and a number of weft wires, which are parallel to each other and cross the warp wires. Although different forms are also possible, the part-body 12 in the present exemplary embodiment is round, so that the individual layers 11 represent circular disks relative to a center axis 21. The individual layers are rotated about the center axis 21 by an angle β relative to each other, so that, for example, weft wires of superimposed layers 11 are respectively rotated relative to each other about this angle β. Thus, there results a different pattern of contact points in each contact plane, distributed over the surface, at which contact points the individual layers are material-bonded to each other by a sintering process. The wires of the one layer cover the mesh of other layers, so that a porous body with multiply angled, not straight, through-pores is formed.

FIG. 7 illustrates the function of the pressure relief body 10 in the event of an explosion occurring in an interior space 22 of a housing. Arranged in the housing wall 23, there is the pressure relief body 10 to enable a rapid pressure equalization originating from the interior space 22 into the environment.

FIG. 7 illustrates such an explosion 24 in the vicinity of the housing wall 23, in which case the pressure wave 25 propagating as a spherical compression shock is depicted by circular arcs at different times. At an earlier time t₀ the pressure wave 25 impinges on the pressure relief body 10. Accordingly, hot gasses penetrate through the part-body 12 and impinge on the intermediate layer 15 at the time t₁. At this point a large-volume transverse flow is possible for the first time, as a result of which the pressure shock—as indicated by arrows 26, 27—spreads radially outward relative to the center axis 21. Therefore, the spread pressure wave penetrates the second part-body 14 along a wide front as illustrated in FIG. 7 by the smaller curvature of the circular arc t₂ which symbolizes the pressure wave. As a result of this, the pressure relief body is penetrated over an enlarged surface. The flow is less concentrated in the center region, and the entire flow resistance decreases.

A flame arrester 10 according to the invention comprises two part-bodies 12, 14, which consist of different wire fabric layers 11, 13 and are connected to one another by an intermediate layer 15 of particularly coarse-meshed wire fabric. The coarse-meshed wire fabric preferably consists of a thick wire. Both the wire diameter and the mesh width of this intermediate layer 15 are preferably much greater than the mesh widths and wire diameters of the wires used for the part-bodies 12, 14.

The pressure relief body 10 according to the invention combines a high degree of mechanical stability with a great flame arresting capability and at the same time very low flow resistance.

Reference Signs:

| | |
|---|---|
| 10 | Pressure relief body/flame arrester |
| 11 | Wire fabric layers |
| 12 | First part-body |
| 13 | Wire fabric layers |
| 14 | Second part-body |
| 15 | Intermediate layer |
| 16, 17 | Cover layers |
| 18 | Wire of the intermediate layer 15 |
| 19 | Wires of the part-bodies 12 |
| 20 | Wire of the cover layer 16 |
| 21 | Center axis |
| 22 | Interior space |
| 23 | Housing wall |
| 24 | Explosion |
| 25 | Pressure wave |
| 26, 27 | Arrows |
| t₀-t₂ | Points in time of the propagating pressure wave 25 |
| R | Direction of flow |

1. A flame arrester comprising:
a number of fabric layers having mesh widths fixed within a mesh width range; and
at least one intermediate layer having a mesh width which is greater than the greatest mesh width fixed within the mesh width range.

2. The flame arrester according to claim 1, wherein the wire fabric layers comprise wires which each have a diameter which is within a fixed wire diameter range.

3. The flame according to claim 1, wherein the intermediate layer comprises wires having a diameters which are greater than the greatest diameter within the wire diameter range.

4. The flame arrester according to claim 1, wherein the mesh width of the intermediate layer is at least 1.5 times greater than the greatest mesh width within the mesh width range.

5. The flame arrester according to claim 1, wherein the diameters of the wires in the intermediate layer is at least 1.5 times greater than the greatest diameter within the wire diameter range.

6. The flame arrester according to claim 1, wherein the intermediate layer is configured so as to define transverse flow channels.

7. The flame arrester according to claim 1, wherein the wire fabric layers have alternatingly larger and smaller mesh widths within the mesh width range.

8. The flame arrester according to claim 1, wherein the wire fabric layers have alternatingly larger and smaller wire diameters within the wire diameter range.

9. The flame arrester according to claim 1, wherein successive wire fabric layers have different orientations.

10. The flame arrester according to claim 1, wherein the wire fabric layers and the intermediate layer are connected together by material-bonding.
